(19) United States
(12) Patent Application Publication
(10) Pub. No.: US 2021/0138941 A1
(43) Pub. Date: May 13, 2021

(54) SEAT AIR CONDITIONING SYSTEM, SEAT AIR CONDITIONER, AND CONNECTION SETTING METHOD

(71) Applicant: DENSO CORPORATION, Kariya-city (JP)

(72) Inventor: Jirou HATTORI, Kariya-city (JP)

(21) Appl. No.: 17/005,472

(22) Filed: Aug. 28, 2020

(30) Foreign Application Priority Data
Nov. 7, 2019 (JP) 2019-202444

(51) Int. Cl. B60N 2/56; B60H 1/00

(52) U.S. Cl. CPC B60N 2/5657; B60N 2/5678; B60H 1/00285; B60N 2/5628

(57) ABSTRACT

A seat air conditioning system includes a seat air conditioner provided for each seat of a vehicle, and a portable terminal configured to control the seat air conditioner. The seat air conditioner controls rotation of a fan with intensity in response to a start signal when starting communication with the portable terminal. The seat air conditioner starts a connection setting process when receiving a response signal in response to the start signal. The portable terminal determines a digital signal by binarizing an intensity of sound detected by a microphone. When the digital signal is the start signal, the portable terminal transmits a response signal to start the connection setting process.

### CROSS REFERENCE TO RELATED APPLICATION

This application is based on Japanese Patent Application No. 2019-202444 filed on Nov. 7, 2019, the disclosure of which is incorporated herein by reference in its entirety.

### TECHNICAL FIELD

The present disclosure relates to a seat air conditioning system, a seat air conditioner of the seat air conditioning system, and a connection setting method for setting a connection between a seat air conditioner and a portable terminal.

### BACKGROUND

A seat air conditioning system is capable of performing air conditioning individually for plural seats in a vehicle. The seat air conditioning system has plural seat air conditioners for the plural seats, respectively. The user can operate the seat air conditioner with the smartphone.

### SUMMARY

According to an aspect of the present disclosure, a seat air conditioner, provided for each seat of a vehicle, includes: a fan that sends conditioned air; an air conditioning controller configured to control rotation of the fan; a vehicle-side short-range communication unit that performs short-range wireless communication with a portable terminal; and an operated-side connection setting unit that performs connection setting with the portable terminal by transmitting and receiving a signal via the vehicle-side short-range communication unit. The air conditioning controller controls the rotation of the fan with intensity in response to a start signal when the vehicle-side short-range communication unit starts communication with the portable terminal. The operated-side connection setting unit starts a connection setting process when receiving a response signal in response to the start signal.

### BRIEF DESCRIPTION OF THE DRAWINGS

FIG. 1 is a schematic view of a seat air conditioning system.

FIG. 2 is a diagram illustrating a configuration of a seat air conditioner.

FIG. 3 is a diagram illustrating an example of a start signal.

FIG. 4 is a diagram illustrating a configuration of a smartphone.

FIG. 5 is a diagram illustrating an example of an operation screen.

FIG. 6 is a diagram illustrating a configuration of a server.

FIG. 7 is a diagram illustrating a process executed by a control unit of the seat air conditioner during pairing.

FIG. 8 is a diagram illustrating a process executed by a control unit of the smartphone during pairing.

FIG. 9 is a diagram illustrating a connection setting process.

### DETAILED DESCRIPTION

To begin with, examples of relevant techniques will be described.

A seat air conditioning system is capable of performing individual air conditioning for plural seats provided in a vehicle. The seat air conditioning system has plural seat air conditioners respectively provided to plural seats in a bus. The user can operate the seat air conditioner with the smartphone. In order to operate the seat air conditioner with the smartphone, it is necessary to set the connection between the smartphone and the seat air conditioner. It is possible to complete the connection setting between the smartphone and the seat air conditioner in advance using a wide area communication.

It is convenient to set up the connection between the smartphone and the seat air conditioner in advance using the wide area communication, because it is not necessary to set up the connection when getting on the bus. However, since the user does not always complete the connection setting in advance, it is also necessary to enable the connection setting when getting on the bus.

The connection setting is also possible when getting on the bus.

Specifically, a two-dimensional code is provided on the seat, and information for setting the connection is stored in the two-dimensional code. The user can set the connection between the smartphone and the seat air conditioner by reading the two-dimensional code with the smartphone.

However, in order for the user to operate the smartphone to read the two-dimensional code, the user needs remembering the reserved seat. If the user forgets the reserved seat, the connection setting becomes difficult.

In addition, in order to set the connection, the user needs operating the smartphone to read the two-dimensional code. If the smartphone is in the bag or pocket of the user when getting on the bus, it is necessary to take the smartphone out of the bag or pocket. Especially, when carrying luggage in both hands, it is troublesome to take out the smartphone when getting on the bus.

Even in case where the connection setting between the seat air conditioner and the smartphone is completed, if the user is seated on a non-reserved seat by mistake, the seat air conditioner will operate meaninglessly.

The present disclosure provides a seat air conditioning system to reduce a user's time and effort for performing a connection setting process between a seat air conditioner provided for each seat and a portable terminal, and to allow the user carrying the portable terminal to easily recognize the reserved seat. Further, the present disclosure provides a seat air conditioner provided in the system, and a connection setting method for setting connection between the seat air conditioner and the portable terminal.

The reference numerals do not limit the disclosed technical scope.

According to an aspect of the present disclosure, a seat air conditioning system includes: a seat air conditioner provided for each seat of a vehicle; and a portable terminal configured to control the seat air conditioner. The seat air conditioner includes a fan that sends conditioned air, an air conditioning controller that controls rotation of the fan, a vehicle-side short-range communication unit that performs short-range wireless communication with the portable terminal, and an operated-side connection setting unit that performs connection setting with the portable terminal by transmitting and receiving a signal via the vehicle-side short-range communication unit. The air conditioning controller controls the rotation of the fan with intensity in response to a start signal when the vehicle-side short-range communication unit starts communication with the portable terminal. The operated-side connection setting unit starts a connection setting process when receiving a response signal in response to the start signal. The portable terminal includes a sound input unit, a binarization processor that binarizes intensity of sound detected by the sound input unit to determine a digital signal, a terminal-side short-range communication unit that communicates with the vehicle-side short-range communication unit, and an operation-side connection setting unit that executes connection setting with the seat air conditioner by transmitting and receiving a signal via the terminal-side short-range communication unit. The operation-side connection setting unit transmits the response signal to start the connection setting process when the digital signal determined by the binarization processor is the start signal.

In the seat air conditioning system, the seat air conditioner audibly generates a start signal for starting the connection setting process, and the portable terminal binarizes the intensity of sound detected by the sound input unit and detects the start signal to start the connection setting process.

Accordingly, the connection setting process is started between the portable terminal and the seat air conditioner even if the user does not perform an operation such as reading an optical code, so as to reduce the time-consuming works for the user. Further, the seat air conditioner generates the sound that means the start signal by the rotation of the fan, and the sound generated by the rotation of the fan is an audible sound that can be heard by a person. Therefore, the user can easily recognize the reserved seat with the seat air conditioner to be operated by determining the seat air conditioner which is generating the sound due to the rotation of the fan.

A seat air conditioner, provided for each seat of a vehicle, includes: a fan that sends conditioned air; an air conditioning controller configured to control rotation of the fan; a vehicle-side short-range communication unit that performs short-range wireless communication with a portable terminal; and an operated-side connection setting unit that performs connection setting with the portable terminal by transmitting and receiving a signal via the vehicle-side short-range communication unit. The air conditioning controller controls the rotation of the fan with intensity in response to a start signal when the vehicle-side short-range communication unit starts communication with the portable terminal. The operated-side connection setting unit starts a connection setting process when receiving a response signal in response to the start signal.

A connection setting method is executed by a seat air conditioning system to set a connection between a portable terminal and a seat air conditioner. The seat air conditioner includes a fan, an air-conditioning controller that controls the fan, a vehicle-side short-range communication unit that performs short-range wireless communication with the portable terminal, and an operated-side connection setting unit that executes connection setting with the portable terminal by transmitting and receiving a signal via the short-range communication unit. The seat air conditioner is provided for each seat of a vehicle. The portable terminal has a sound input unit and a terminal-side short-range communication unit that communicates with the vehicle-side short-range communication unit. The connection setting method includes: controlling rotation of the fan with intensity in response to a start signal when the vehicle-side short-range communication unit starts communication with the portable terminal by the air conditioning controller; starting the connection setting process by the operated-side connection setting unit when receiving a response signal in response to the start signal; determining a digital signal by binarizing intensity of sound detected by the sound input unit; and starting the connection setting process by sending the response signal when the digital signal is the start signal.

### (Entire Configuration)

FIG. 1 is an overall configuration diagram of a seat air conditioning system 1. A schematic configuration of the seat air conditioning system 1 will be described with reference to FIG. 1. The seat air conditioning system 1 includes a seat air conditioner 10, a smartphone 20 that is a portable terminal, and a server 30.

The seat air conditioner 10 is installed on each of plural seats 3 provided in a vehicle 2, where a seat reservation is possible. Before getting on the vehicle 2, the passenger can reserve one of the seats 3 by designating. The number of seats 3 in the vehicle 2 can be set suitably. The vehicle 2 may have two to four rows of seats 3. The vehicle 2 may be a bus having a large number of the seats 3.

The seat air conditioner 10 is installed at the lower part of the seat 3. The seat air conditioner 10 conditions air for the seat 3 and the vicinity thereof. The seat air conditioner 10 can be operated by the smartphone 20.

A two-dimensional code 40 is provided on the seat 3. The two-dimensional code 40 stores a seat number and a BD address required for the smartphone 20 to make a connection setting for short-range communication with the seat air conditioner 10. However, in the present embodiment, the smartphone 20 can start the connection setting with the seat air conditioner 10 by executing a connection setting method using a sound generated by the seat air conditioner 10 even if the smartphone 20 does not read the two-dimensional code 40.

In the present embodiment, the short-range communication is specifically according to the Bluetooth (registered trademark) standard (hereinafter, Bluetooth communication). The connection setting is called as pairing. The two-dimensional code 40 is, for example, printed on a seat cover of the seat 3 so as to show the two-dimensional code 40 on the seat 3. Further, the two-dimensional code 40 stores a command for causing the smartphone 20 to display an operation screen for operating the seat air conditioner 10.

The smartphone 20 is carried by the user 4. The smartphone 20 has the Bluetooth communication function and a wide area communication function. Further, the smartphone 20 has a microphone 22 (see FIG. 4) which is a sound input unit. The smartphone 20 can wirelessly operate the seat air conditioner 10 by performing pairing with the seat air conditioner 10.

The server 30 can communicate with the smartphone 20 and the vehicle 2 via the wide area communication network 5. The server 30 manages the reservation status of the seats 3 of the vehicle 2.

### (Configuration of Seat Air Conditioner 10)

As shown in FIG. 2, the seat air conditioner 10 includes an air conditioning unit 11, a vehicle-side short-range communication unit 13, and a control unit 14. The control unit 14 is connected to the in-vehicle LAN 7 and is capable of performing wired communication with the wide area communication device 6 mounted on the vehicle 2 via the in-vehicle LAN 7. The wide area communication device 6 performs wide area communication, which is wireless communication, via the wide area communication network 5. Further, one of the control units 14 of the plural seat air conditioners 10 mounted on the vehicle 2 can communicate with the other control units 14 of the other seat air conditioners 10 via the in-vehicle LAN 7.

The air conditioning unit 11 is a mechanical structure that blows out air to adjust temperature or humidity around the seat 3 in which the seat air conditioner 10 is installed. The air conditioning unit 11 includes a fan 12 for blowing conditioned air.

The vehicle-side short-range communication unit 13 is a communication unit that is capable of directly performing the short-range communication with another communication device that is capable of performing the short-range wireless communication. In this embodiment, as described above, the short-range communication is provided by Bluetooth communication.

The control unit 14 is a computer (hereinafter, may be referred to as a microcomputer) including a CPU, a ROM, a RAM, and I/O, which are connected by a bus line. A program for causing a general-purpose microcomputer to function as the control unit 14 is stored in the ROM. When the CPU executes the program stored in the ROM while using the temporary storage function of the RAM, the control unit 14 functions as an air conditioning controller 15 and an operated-side connection setting unit 16. When these functions are executed, a method corresponding to the program stored in the ROM is executed.

The storage medium that stores the program executed by the CPU is not limited to the ROM, and the program may be stored in a non-transitory tangible storage medium. For example, the program may be stored in a flash memory. In addition, a part or all of the functions of the control unit 14 may be realized by using one or more ICs (in other words, as hardware). In addition, a part or all of the functions of the control unit 14 may be realized by a combination of software execution by the CPU and hardware components.

The air conditioning controller 15 operates the air conditioning unit 11 with the setting determined by a setting operation by the user 4. The setting operation is performed by the user 4 via the paired smartphone 20, and a command signal determined by the setting operation is transmitted from the smartphone 20 to the seat air conditioner 10. The smartphone 20 transmits the command signal by Bluetooth communication. In the seat air conditioner 10, the vehicle-side short-range communication unit 13 receives the command signal. When the command signal is acquired from the vehicle-side short-range communication unit 13, the air conditioning controller 15 controls the air conditioning unit 11 according to the command signal.

When an activation signal is input, the air conditioning controller 15 is activated and controls the rotation of the fan 12 in response to the instructed start signal that was previously stored. The start signal is a binary signal of “0” and/or “1”. FIG. 3 shows an example of the start signal. The start signal shown in FIG. 3 is “1011”.

When the start signal is “1011”, the air conditioning controller 15 sets the drive voltage for driving the fan 12 to a predetermined max value from time t0 to time t1. From time t1 to time t2, the drive voltage is set to 0 and the power supply to the fan 12 is stopped. Next, the drive voltage is set to the max value from time t2 to time t3, and the drive voltage is maintained at the max value also from time t3 to time t4. Then, the drive voltage is set to zero. The intervals from time t0 to time t1, time t1 to time t2, time t2 to time t3, and time t3 to time t4 are the same. The max value can be the maximum voltage that can be applied, but is not necessarily the maximum voltage that can be applied. The max value is set so that the rotation of the fan 12 produces a sound that can be recognized by the smartphone 20 and the user 4.

The operated-side connection setting unit 16 generates a signal for executing pairing, and the signal is sent from the vehicle-side short-range communication unit 13 to the smartphone 20.

### (Configuration of Smartphone 20)

As shown in FIG. 4, the smartphone 20 includes a camera 21, a microphone 22, an input receiver 23, a display unit 24, a terminal-side short-range communication unit 25, a wide area communication unit 26, a terminal memory 27, and a control unit 28.

The camera 21 is used to image the two-dimensional code 40. The microphone 22 detects a sound around the smartphone 20. The input receiver 23 is, for example, a touch panel. The input receiver 23 receives various setting inputs when the user 4 operates the seat air conditioner 10.

The display unit 24 can display various images. The display unit 24 is, for example, a liquid crystal display or an organic EL display. The terminal-side short-range communication unit 25 is capable of Bluetooth communication, which is short-range communication. The short-range communication may be according to Wi-Fi (registered trademark) communication standard.

The wide area communication unit 26 performs the wide area wireless communication. The wide area communication unit 26 is capable of performing both transmission and reception, and performing the wide area communication with the seat air conditioner 10 and the server 30. The terminal memory 27 is a writable non-volatile memory. The terminal memory 27 stores the seat identification information for specifying the seat air conditioner 10, which is acquired when the seat 3 provided with the seat air conditioner 10 is reserved. The seat identification information can be, for example, BD address of the vehicle-side short-range communication unit 13 included in the seat air conditioner 10.

The control unit 28 is a microcomputer including a CPU, a ROM, a RAM, and an I/O, which are connected by a bus line. The ROM stores a wireless operation program for causing a general-purpose microcomputer to function as the control unit 28. When the CPU executes the wireless operation program stored in the ROM while using the temporary storage function of the RAM, the control unit 28 functions as the binarization processor 281, the operation-side connection setting unit 282, the reservation processor 283, the wireless operation unit 284 and the display controller 285. When the above-described functions are executed, a method corresponding to the wireless operation program is executed.

The binarization processor 281 binarizes the intensity of the sound detected by the microphone 22. That is, the intensity of the sound detected by the microphone 22 is represented by 0 or 1 in the binarization processor 281. Various methods can be adopted as the method of the binarization processing. For example, the microphone 22 is always activated on. When the volume of the sound detected by the microphone 22 is equal to or higher than a threshold, the binarization processor 281 outputs “1” for the time. When the volume of the sound detected by the microphone 22 is smaller than the threshold, the binarization processor 281 outputs “0” for the time.

As another method, it is possible to determine whether or not the sound detected by the microphone 22 is highly likely to represent binary according to the volume. In this case, the binarization processor 281 detects a change in the volume of the sound detected by the microphone 22 for a certain period of time. The certain period of time is the entire time length of the start signal set in advance. The binarization processor 281 determines that the sound detected by the microphone 22 is highly likely to represent binary according to the volume if the sound volume is substantially the same when the sound detected by the microphone 22 for a certain period of time is equal to or higher than the detection threshold. Then, the binarization processor 281 binarizes the sound during the certain period of time. At this time, the time zone of the volume in which the sound detected by the microphone 22 is equal to or higher than the detection threshold is set to the time zone of “1”, and the other time zones are set to the time zone of “0”. After that, the number of consecutive “1” and “0” is determined by dividing the time zone of “1” and the time zone of “0” by the unit time stored in advance.

Further, instead of always activating on the microphone 22, the microphone 22 can be turned on when it is detected that the terminal-side short-range communication unit 25 can receive the radio wave transmitted by the vehicle-side short-range communication unit 13. Even if the pairing is not performed, the terminal-side short-range communication unit 25 can receive the radio wave transmitted by the vehicle-side short-range communication unit 13 and determine the intensity of the received radio wave.

When the digital signal determined by the binarization processor 281 is the start signal, the operation-side connection setting unit 282 transmits a response signal from the terminal-side short-range communication unit 25 to start the connection setting process. The connection setting process is required to establish a communication connection between the smartphone 20 and the vehicle-side short-range communication unit 13 of the seat air conditioner 10. Specific connection setting processing will be described later.

The reservation processor 283 performs a process according to the signal input from the input receiver 23 to communicate with the server 30 using the wide area communication unit 26, and performs a reservation process of reserving the seat 3 of the vehicle 2. In the reservation process, in addition to the reservation of the seat 3, the BD address set in the seat 3 is notified from the server 30. The reservation processor 283 stores the notified BD address in the terminal memory 27.

The wireless operation unit 284 executes various processes for wirelessly operating the seat air conditioner 10 with the smartphone 20 while the smartphone 20 is communicating with the seat air conditioner 10. As one of the processes, the wireless operation unit 284 provides the display controller 285 with an operation screen for the user 4 to change the setting of the seat air conditioner 10. The display controller 285 displays the operation screen on the display unit 24. FIG. 5 shows an example of the operation screen. The user 4 can change the setting of the seat air conditioner 10 by touching this operation screen. The wireless operation unit 284 transmits the set value determined based on the operation of the user 4 from the terminal side short-range communication unit 25 to the seat air conditioner 10.

The display controller 285 causes the display unit 24 to display various images. For example, the display controller 285 causes the display unit 24 to display an image determined by the operating state of the reservation processor 283 while the reservation processor 283 is executing the reservation processing. In addition, the display controller 285 causes the display unit 24 to display an image determined by the operating state of the wireless operation unit 284 while the wireless operation unit 284 is performing a process for wirelessly operating the seat air conditioner 10. Further, when the connection setting process is completed, the display controller 285 causes the display unit 24 to display information identifying the seat air conditioner 10 for which the connection setting process is completed.

The information for identifying the seat air conditioner 10 for which the connection setting process has been completed can be in an image format, a character format, a format combining images and characters, or the like. For example, an image schematically showing all the seats 3 included in the vehicle 2 is displayed on the display unit 24, and the image of the seat 3 with the seat air conditioner 10 for which the connection setting is completed is highlighted. In addition, the information for identifying the seat air conditioner 10 for which the connection setting process has been completed can be indicated by text such as the row number or the column number in the right-left or front-rear direction.

### (Configuration of Server 30)

As shown in FIG. 6, the server 30 includes a wide area communication unit 31, a memory 32, and a control unit 33. The wide area communication unit 31 is provided as a communication unit that performs wide area communication. The memory 32 is provided as an electromagnetic storage medium that electrically or magnetically stores information.

The memory 32 is, for example, a flash memory. The memory 32 stores the reservation status of each seat 3 for plural vehicles 2 managed by the server 30. The reservation status represents a reserved boarding section for each seat 3 of the vehicle 2. Further, the memory 32 stores a correspondence relationship between each seat 3 of the vehicle 2 and the seat air conditioner 10 installed on the seat 3. The BD address is also stored in the memory 32 in association with each seat air conditioner 10.

The control unit 33 is a microcomputer including a CPU, a ROM, a RAM and an I/O, which are connected by a bus line. A program for causing a general-purpose microcomputer to function as the control unit 33 is stored in the ROM. The control unit 33 functions as the reservation management unit 34 when the CPU executes the program stored in the ROM while using the temporary storage function of the RAM.

The reservation management unit 34 sequentially updates the reservation status stored in the memory 32. The reservation status is updated by connecting to the smartphone 20 or another terminal having a reservation function.

### (Flow of Pairing)

The flow of pairing will be described with reference to FIG. 7 to FIG. 9. FIG. 7 shows a process executed by the control unit 14 of the seat air conditioner 10, and FIG. 8 shows a process executed by the control unit 28 of the smartphone 20. The control unit 14 of the seat air conditioner 10 executes the process shown in FIG. 7 when the activation signal is input from the in-vehicle LAN 7. The activation signal can be set in various ways. The activation signal can be, for example, a signal indicating that the door of the vehicle 2 is opened. Further, the activation signal may be set when the smartphone 20 is detected to be present within a certain range of the vehicle 2. When the smartphone 20 sequentially transmits radio waves having a frequency that can be received by the vehicle-side short-range communication unit 13, the distance between the vehicle 2 and the smartphone 20 can be estimated based on the intensity of the radio waves.

The activation signal is common to the plural seat air conditioners 10 respectively installed in the plurality seats 3 of the vehicle 2. Therefore, the control units 14 of the plural seat air conditioners 10 start the processing shown in FIG. 7 at the same time. In the process shown in FIG. 7, steps other than S1 and S3 are executed by the air conditioning controller 15, and S1 and S3 are executed by the operated-side connection setting unit 16.

In step (hereinafter, step is omitted) S1, the air conditioning controller 15 gives the fan 12 a rectangular voltage representing a start signal as a drive voltage. As a result, the fan 12 rotates with the intensity corresponding to the start signal.

In S2, the vehicle-side short-range communication unit 13 is activated. In S3, the connection setting process is performed. The connection setting process is shown in FIG. 9 and includes the process executed by the control unit 28 of the smartphone 20, so the connection setting process will be described later. After the connection setting process is completed, S4 is executed.

In S4, it is determined whether or not the connection with the smartphone 20 has succeeded. If the connection is successful, the determination result of S4 is YES and the process proceeds to S5. In S5, the other seat air conditioner 10 is notified that the connection with the smartphone 20 has been successful. In subsequent S6, air conditioning is started with the setting set at this point.

If the determination result in S4 is NO, the process proceeds to S7. In S7, it is determined whether or not the success of the connection is notified from another seat air conditioner 10. If the determination result of S7 is YES, the process progresses to S8. In S8, the voltage applied to the fan 12 is set to zero. As a result, the fan 12 gradually decelerates due to air resistance or the like, and eventually stops.

If the determination result of S7 is NO, the process progresses to S9. In S9, it is determined whether the fan control time has elapsed. The fan control time is preset. The fan control time can be, for example, a time period during which the rectangular waveform representing the start signal can be applied several times. If the determination result in S9 is NO, the process returns to S1 and the processes from S1 onward are executed again. If the determination result of S9 is YES, S8 is executed and the fan 12 is stopped.

Next, FIG. 8 will be described. The control unit 28 of the smartphone 20 repeatedly executes the process shown in FIG. 8 while the microphone 22 is turned on. In FIGS. 8, S11 and S12 are executed by the binarization processor 281, and S13 and S14 are executed by the operation-side connection setting unit 282.

In S11, the sound detected by the microphone 22 is acquired. In S12, the sound acquired in S11 is binarized. In S13, it is determined whether or not the digital signal obtained by the binarization processing in S12 is a start signal. If the determination result in S13 is YES, the process proceeds to S14. If the determination result in S13 is NO, the process of FIG. 8 ends.

FIG. 9 shows the connection setting process. The connection setting process shown in FIG. 9 is a process procedure defined in the Bluetooth standard. The process in the smartphone 20 is executed by the operation-side connection setting unit 282, and the process in the seat air conditioner 10 is executed by the operated-side connection setting unit 16.

In S31, a connection establishment request signal is transmitted to the seat air conditioner 10. This connection establishment request signal is a signal that is transmitted to the seat air conditioner 10 when it is determined that the binarized sound in S12 is a start signal. This connection establishment request signal is a response signal that responds to the start signal. The connection establishment request signal can be transmitted to the seat air conditioner 10 installed in the reserved seat 3, since the BD address of the seat air conditioner 10 installed in the seat 3 is acquired when the seat 3 is reserved. The connection establishment request signal includes the address information of the smartphone 20 and the authentication code. The authentication code is, for example, a passkey.

The seat air conditioner 10 receives this connection establishment request signal in S41. In S42, a signal for requesting a random number information for generating the encryption key is transmitted to the smartphone 20. The smartphone 20 receives the request in S32. In S33, a random number is generated by a predetermined function or the like. In S34, the random number generated in S33 is transmitted to the seat air conditioner 10. In S35, an encryption key is generated based on the authentication code transmitted in S31, the random number transmitted in S34, and the encryption generation algorithm.

The seat air conditioner 10 receives the random number transmitted from the smartphone 20 in S43. In S44, the encryption key is generated based on the random number received in S43, the authentication code received in S41, and the encryption generation algorithm. The encryption generation algorithm used here is a common algorithm to the encryption generation algorithm used in the smartphone 20.

The pairing is completed by the above-described processing. Thereafter, in Bluetooth communication between the smartphone 20 and the seat air conditioner 10, an encrypted signal is transmitted and received using this encryption key.

According to the seat air conditioning system 1 of the embodiment, the seat air conditioner 10 generates the start signal for starting the connection setting process using the sound by rotating the fan 12 (S1). The smartphone 20 includes the microphone 22, and detects the start signal for starting the connection setting process by binarizing the sound detected by the microphone 22 (S12, S13).

Thus, the connection setting process is started between the smartphone 20 and the seat air conditioner 10 even if the user 4 does no operation such as reading the optical code (S3, S14). Therefore, the labor of the user 4 is reduced. In addition, the seat air conditioner 10 generates the sound that means the start signal by the rotation of the fan 12. The sound generated by the rotation of the fan 12 includes sound of the conditioned air, so that the sound is an audible sound that can be heard by humans. Therefore, the user 4 can easily recognize the reserved seat 3 with the seat air conditioner 10 to be operated by determining the seat air conditioner 10 which is generating the sound by the rotation of the fan 12.

The activation signal is common for the control units 14 of the plural seat air conditioners 10 to start the process of rotating the fan 12 in response to the intensity of the start signal. Therefore, the plural control units 14 start the processing shown in FIG. 7 at the same time. As a result, the fans 12 of all the seat air conditioners 10 operate once. However, when it is notified that the connection setting between the other seat air conditioner 10 and the smartphone 20 is completed (S7), the rotation of the fan 12 is stopped (S8). On the other hand, since the seat air conditioner 10 that has been successfully connected to the smartphone 20 starts air conditioning, the operation of the fan 12 continues. Therefore, the user 4 can easily recognize the reserved seat 3 by confirming the continuing sound generated by the operation of the fan 12 of the seat air conditioner 10.

In the present embodiment, the air conditioning controller 15 suspends the power supply to the fan 12 when the rotation of the fan 12 is reduced in response to the start signal. Thus, even when the rotation of the fan 12 is reduced according to the start signal, the fluctuation of the rotation speed of the fan 12 according to the start signal is large as compared with the case where the power supply of the fan 12 is not stopped. Therefore, the binarization processor 281 of the smartphone 20 can easily detect the start signal.

When the seat 3 with the seat air conditioner 10 is reserved, the smartphone 20 stores the BD address in the terminal memory 27 for specifying the vehicle-side short-range communication unit 13 of the seat air conditioner 10 from the server 30. In the connection setting process, the operation-side connection setting unit 282 executes the connection setting process with the seat air conditioner 10 determined by the BD address stored in the terminal memory 27. Therefore, even if communication is possible with the plural seat air conditioners 10, the connection settings can be made with the seat air conditioner 10 of the reserved seat 3.

Furthermore, the smartphone 20 includes the display unit 24. When the connection setting process is completed, the display unit 24 displays information that identifies the seat air conditioner 10 for which the connection setting process is completed. This also allows the user 4 to easily recognize the reserved seat 3.

Although the embodiment is described above, the disclosed technology is not limited to the above-described embodiment, and the following modifications are included in the disclosed range, and various modifications can be made without departing from the spirit except as described below.

### (First Modification)

In the embodiment, when the activation signal is input, all the seat air conditioners 10 mounted on the vehicle 2 start the process shown in FIG. 7. However, the seat air conditioner 10 reserved by the reservation process may be notified from the server 30 via the wide area communication device 6 that the reservation has been made. When the activation signal is input, only the seat air conditioner 10 that has been notified of the reservation may execute the processing shown in FIG. 7. In this case, the processes of S5 and S7 can be omitted.

### (Second Modification)

In the embodiment, the Bluetooth communication has been described as the short-range wireless communication. However, the short-range wireless communication is not limited to the Bluetooth communication. For example, the short-range wireless communication may be Wi-Fi.

### (Third Modification)

In the embodiment, the plural seat air conditioners 10 can communicate with each other by wired communication via the in-vehicle LAN 7. However, the plural seat air conditioners 10 may communicate with each other by the vehicle-side short-range communication unit 13.

### (Fourth Modification)

The control unit and the method thereof described in the present disclosure may be realized by a dedicated microcomputer that constitutes a processor programmed to execute one or more functions embodied by a computer program. Alternatively, the control unit and its method described in the present disclosure may be realized by a dedicated hardware logic circuit. Alternatively, the control unit and its method described in the present disclosure may be realized by one or more dedicated microcomputers configured by a combination of a processor that executes a computer program and one or more hardware logic circuits. The hardware logic circuit is, for example, an ASIC or FPGA.

Further, the storage medium for storing the computer program is not limited to the ROM, and may be stored in a non-transitional tangible recording medium readable by the microcomputer as an instruction executed by the microcomputer. For example, the program may be stored in the flash memory.

What is claimed is:

1. A seat air conditioning system comprising:
a seat air conditioner provided for each seat of a vehicle, and
a portable terminal configured to control the seat air conditioner, wherein
the seat air conditioner includes
a fan that sends conditioned air,
an air conditioning controller that controls rotation of the fan,
a vehicle-side short-range communication unit that performs short-range wireless communication with the portable terminal, and
an operated-side connection setting unit that performs connection setting with the portable terminal by transmitting and receiving a signal via the vehicle-side short-range communication unit,
the air conditioning controller controls the rotation of the fan with intensity in response to a start signal when the vehicle-side short-range communication unit starts communication with the portable terminal,
the operated-side connection setting unit starts a connection setting process when receiving a response signal in response to the start signal,
the portable terminal includes
a sound input unit,
a binarization processor that binarizes intensity of sound detected by the sound input unit to determine a digital signal,
a terminal-side short-range communication unit that communicates with the vehicle-side short-range communication unit, and
an operation-side connection setting unit that executes connection setting with the seat air conditioner by transmitting and receiving a signal via the terminal-side short-range communication unit, and
the operation-side connection setting unit transmits the response signal to start the connection setting process when the digital signal determined by the binarization processor is the start signal.

2. The seat air conditioning system according to claim 1, wherein
the seat air conditioner is one of a plurality of seat air conditioners,
the air conditioning controllers of the plurality of seat air conditioners rotate the fan with intensity in response to the start signal based on a common activation signal, and
when it is notified that the connection setting is completed between one of the seat air conditioners and the portable terminal, the rotation of the fan is stopped by the air conditioning controller of the other seat air conditioners.

3. The seat air conditioning system according to claim 1, wherein
the air conditioning controller stops power supply to the fan to reduce the rotation of the fan in response to the start signal.

4. The seat air conditioning system according to claim 2, wherein
the portable terminal includes a non-volatile terminal memory that stores seat identification information that specifies one of the plurality of seat air conditioners, the seat identification information being acquired when the seat with the one of the plurality of seat air conditioners is reserved, and
the operation-side connection setting unit performs the connection setting process with the seat air conditioner identified by the seat identification information stored in the terminal memory, when a communication is possible with the plurality of seat air conditioners.

5. The seat air conditioning system according to claim 1, wherein
the portable terminal includes
a display unit, and
a display controller configured to display, when the connection setting process is completed, information specifying the seat air conditioner for which the connection setting process is completed, on the display unit.

6. A seat air conditioner, provided for each seat of a vehicle, comprising:
a fan that sends conditioned air;
an air conditioning controller configured to control rotation of the fan;
a vehicle-side short-range communication unit that performs short-range wireless communication with a portable terminal; and
an operated-side connection setting unit that performs connection setting with the portable terminal by transmitting and receiving a signal via the vehicle-side short-range communication unit, wherein
the air conditioning controller controls the rotation of the fan with intensity in response to a start signal when the vehicle-side short-range communication unit starts communication with the portable terminal, and
the operated-side connection setting unit starts a connection setting process when receiving a response signal in response to the start signal.

7. A connection setting method to set a connection between a portable terminal and a seat air conditioner for a seat air conditioning system, wherein
the seat air conditioner includes a fan, an air-conditioning controller that controls the fan, a vehicle-side short-range communication unit that performs short-range wireless communication with the portable terminal, and an operated-side connection setting unit that executes connection setting with the portable terminal by transmitting and receiving a signal via the short-range communication unit,
the seat air conditioner being provided for each seat of a vehicle,
the portable terminal has a sound input unit and a terminal-side short-range communication unit that communicates with the vehicle-side short-range communication unit, the connection setting method comprising:
controlling rotation of the fan with intensity in response to a start signal when the vehicle-side short-range communication unit starts communication with the portable terminal by the air conditioning controller;
starting a connection setting process by the operated-side connection setting unit when receiving a response signal in response to the start signal;
determining a digital signal by binarizing an intensity of sound detected by the sound input unit, and
starting the connection setting process by sending the response signal when the digital signal is the start signal.
